(19) United States
(12) Patent Application Publication
(10) Pub. No.: US 2026/0130541 A1
(43) Pub. Date: May 14, 2026

(54) PROBABILITY-BASED CONTROL OF A COOKING APPLIANCE

(71) Applicant: BREVILLE PTY LIMITED, Alexandria, New South Wales (AU)

(72) Inventor: Douglas Eugene BALDWIN, Torrance, CA (US)

(73) Assignee: BREVILLE PTY LIMITED, Alexandria, New South Wales (AU)

(21) Appl. No.: 19/119,282

(22) PCT Filed: Oct. 5, 2023
(86) PCT No.: PCT/AU2023/050958

§ 371 Date: Apr. 8, 2025

(30) Foreign Application Priority Data
Oct. 10, 2022 (AU) 2022902958

(51) Int. Cl. A47J 36/32; A47J 37/08; A47J 43/07; F24C 15/32; G05B 19/042

(52) U.S. Cl. CPC A47J 36/32; A47J 37/0871; A47J 43/0716; G05B 19/042; F24C 15/322; G05B 2219/25257

(57) ABSTRACT

A cooking appliance (100) including: a heating element (102) and/or a motor (104) for processing a food item from a first state to a desired state, each state being associated with a physical quantity: a sensor (106) to measure the physical quantity: a microcontroller (110) configured to control the heating element and/or the motor at one or more set points; and a memory (120) connected to the microcontroller (110) for storing information, the memory (120) storing a loss function and a sensor function; wherein the microcontroller (110) receives sensor information from the sensor (106) related to the physical quantity and is configured to: commence processing of the food item by activating the heating element (102) and/or the motor (104): at time tₙ, determine a first probability associated with the food item being in the first state or the desired state based on the sensor information and the sensor function: determine a loss value for each set point of the heating element (102) and/or the motor (104), the loss value being based on the first probability and the loss function; and operate the heating element (102) and/or the motor (104) at the respective set point with the lowest loss value.

### RELATED APPLICATIONS

This application claims convention priority from Australian Provisional Patent Application No. 2022902958, the contents of which are incorporated herein in their entirety by reference thereto.

### FIELD

This invention relates to a cooking appliance being controlled by a microcontroller according to a probability-based control algorithm.

### BACKGROUND

Consumer demands on cooking appliances increasingly include more precision in the outcome of food processing steps provided by the cooking appliance. For example, blenders should now be able to reliably process ice cubes to a certain fragment size, ovens should be able to reliably cook meat to precise internal temperatures, preferably without the use of meat temperature probes. In particular, protein-based food processing such as cooking eggs, making custard, or recipes that are strongly affected by the boiling point of water, should automatically adjust for environmental factors, such as whether the appliance is being used in a high-altitude town in South America, or below sea level in the Netherlands.

Existing deterministic control schemes increasingly fail to address these consumer demands, because in order to meet these requirements, the complexity of the deterministic system, its sensor inputs increases exponentially, while making clairvoyant demands on control system developers to speculate how the consumer environment might differ from the test environment.

### SUMMARY

It is an object of the present invention to at least substantially address one or more of the above disadvantages, or at least provide a useful alternative to the above control systems for cooking appliances.

In a first aspect, the present invention provides a cooking appliance including:
a heating element and/or a motor for processing a food item from a first state to a desired state, each state being associated with a physical quantity;
a sensor to measure the physical quantity;
a microcontroller configured to control the heating element and/or the motor at one or more set points; and
a memory connected to the microcontroller for storing information, the memory storing a loss function and a sensor function;
   wherein the microcontroller receives sensor information from the sensor related to the physical quantity and is configured to:
commence processing of the food item by activating the heating element and/or the motor;
at time tₙ, determine a first probability associated with the food item being in the first state or the desired state based on the sensor information and the sensor function;
determine a loss value for each set point of the heating element and/or the motor, the loss value being based on the first probability and the loss function; and
operate the heating element and/or the motor at the respective set point with the lowest loss value.

Preferably, the sensor function includes a physics-based model defining a relationship between the physical quantity measured by the sensor and a probability that the food item is in the first state or the desired state, and the microcontroller is configured to determine the first probability also based on the physics-based model.

Preferably, the physical quantity changes value between the first state and the desired state, and the sensor function includes:
a variable function that defines a relationship between the physical quantity and a probability that the food item is in the first state or the desired state; and
a constant function that defines a relationship between a physical constant and a probability that the food item is in the first state or the desired state, wherein the physical constant does not change value between the first state and the desired state.

Preferably, the microcontroller is configured to:
at time tₙ₊₁, determine a second probability associated with the food item being in the first state or the desired state by applying Bayesian inference to the first probability, based on the sensor information received by the microcontroller between tₙ and tₙ₊₁ and the sensor function; and
determine the loss value for each set point of the heating element and/or the motor based on the second probability and the loss function.

Preferably, the microcontroller is configured to update the sensor function using a Kalman filter based on the sensor information received by the microcontroller between tₙ and tₙ₊₁, and

Preferably, the memory stores a physics-based model defining a relationship between the physical quantity measured by the sensor, the time tₙ₊₁, and a probability that the food item is in the first state or the desired state, and the microcontroller is configured to determine the loss value also based on the physics-based model.

Preferably, the microcontroller is configured to determine a processing intensity of the heating element and/or the motor; and
wherein the sensor function includes a Markov chain based on the time tₙ₊₁ and the processing intensity such that the first probability calculated at a time tₙ₊₂ using the sensor function including the Markov chain is closer to the second probability calculated at the time tₙ₊₂ than a third probability calculated at a time tₙ₊₂ using the sensor function without the Markov chain.

Preferably, the processing intensity is determined by the microcontroller by determining a thermal load imparted on the food item based on the set point of the heating element and a time the heating element operated at the set point.

Preferably, the food item is processed from the first state to one or more second states and subsequently to the desired state, the microcontroller also being configured to determine the first probability for each second state.

Preferably, the microcontroller is also configured to determine the second probability for each second state.

Preferably, the microcontroller is configured to only determine the loss value for second states where the second probability exceeds a performance threshold.

Preferably, the microcontroller is configured to only determine the loss value for second states where the loss function exceeds the performance threshold.

Preferably, the microcontroller is configured to determine the loss function based on a user input of the desired state of the food item.

Preferably, the heating element and/or the motor have a power-off set point, and the microcontroller is configured to determine the loss function such that the loss value of the power-off set point is lower than the loss value of other set points when the first probability of the food item being in the desired state has passed a finish threshold.

Preferably, at time tₙ, the microcontroller is configured to adjust the sensor function based on a user input of the first state, and a user input model defining a relationship between the user input and a probability that the food item is in the first state or the desired state.

Preferably, the physical quantity is continuous and there is a continuous distribution of states of the food item between the first state and the desired state, and
wherein the first probability is a continuous probability function from the first state to the desired state, and
wherein the user input model is a continuous probability function over the continuous distribution of states of the food item based on the user input.

Preferably, the first probability is stored by the memory as a first evidence, the first evidence being defined as the logarithmic ratio of the first probability of the food item being in the relevant state and the first probability of the food item being in any state but the relevant state, such that the first probability is storable as a signed float.

In a second aspect, the present invention provides a computer-readable memory containing executable instructions for the cooking appliance of the first aspect, the executable instructions being adapted to configure the microcontroller of the first aspect.

In a third aspect, the present invention provides a method for controlling a cooking appliance, the cooking appliance including:
a heating element and/or a motor for processing a food item from a first state to a desired state, each state being associated with a physical quantity;
a sensor to measure the physical quantity;
a microcontroller configured to control the heating element and/or the motor at one or more set points; and
a memory connected to the microcontroller for storing information, the memory storing a loss function and a sensor function,
   the method including the steps of:
commencing processing of the food item by activating the heating element and/or the motor;
at time tₙ, determining a first probability associated with the food item being in the first state or the desired state based on the sensor information and the sensor function;
determining a loss value for each set point of the heating element and/or the motor, the loss value being based on the first probability and the loss function; and
operating the heating element and/or the motor at the respective set point with the lowest loss value.

### BRIEF DESCRIPTION OF THE DRAWING

Preferred embodiments of the present invention will now be described by way of example, with reference to the accompanying drawings, wherein:

FIG. 1 is an isometric view of a cooking appliance according to an embodiment of the invention.

FIG. 2 is a section view of a cooking appliance according to an embodiment of the invention.

FIG. 3 is a flowchart of a control system of a cooking appliance according to a preferred embodiment of the invention.

FIG. 4 is a further flowchart of the control system of FIG. 3, including using a physics-based model to determine a first probability.

FIG. 5 is a further flowchart of the control system of FIG. 3, including using Bayesian inference to determine a second probability, based on the first probability.

FIG. 6 is a further flowchart of the control system of FIG. 3, including processing the food item to a second state, before processing the food item to a desired state.

FIG. 7 is a further flowchart of the control system of FIG. 3, including the determination of a processing intensity and use of a Markov chain to advance the physical model based on the processing intensity.

FIG. 8 is a further flowchart of the control system of FIG. 3, including the use of a Kalman filter to update a sensor function.

FIG. 9 is a further flowchart of the control system of FIG. 3, including using the physics-based model to determine a loss value.

FIG. 10 is a further flowchart of the control system of FIG. 3, including the use of a user input to adjust the sensor function, based on a user input function.

### DETAILED DESCRIPTION

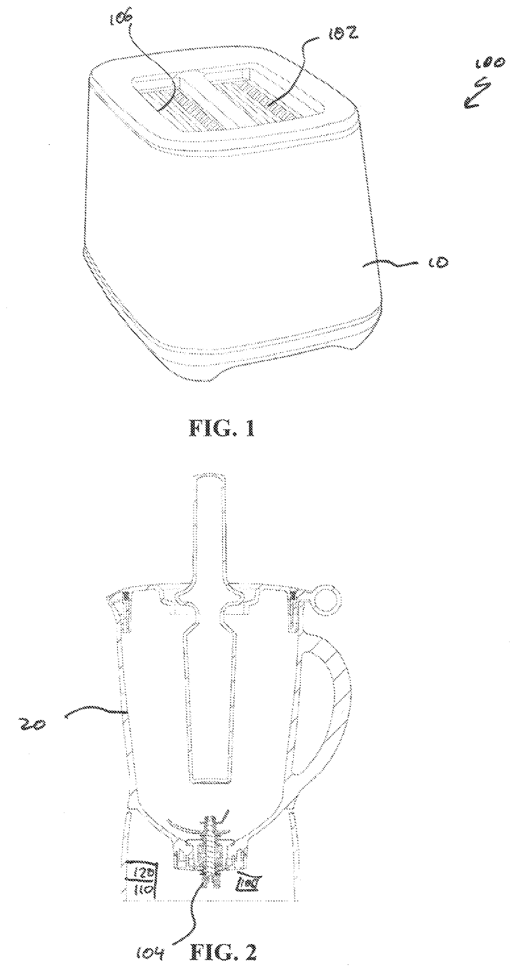

As shown in FIGS. 1 and 2, a cooking appliance 100 according to a preferred embodiment of the invention may include, for example, a toaster 10, or a blender 20. In another embodiment, the invention may include a coffee machine. The cooking appliance 100 typically includes at least one of a heating element 102 and/or a motor 104 for processing a food item (not shown) from a first state to a desired state, each state being associated with a physical quantity. In the example of the toaster 10, the food item is a piece of bread that is being processed by the heating element 102 from the first state (untoasted, or even frozen) to the desired state (a user-selected shade of toasted). In this specification the term “first state” generally refers to the current state of the food item, while the term “desired state” generally refers to the state of the food item that is to be achieved by the processing of the cooking appliance 100. The physical quantity in this case is the progression of the Maillard, caramelization, and/or combustion reactions at the surface of the toast, usually indicated by a browning of the toast surface. In the example of the blender 20, the food item is perhaps a volume of ice cubes that are being processed from the first state (original ice cube shape and size) to the desired state (a user-selected fragment size of ice, or perhaps ice slush). The physical quantity in this case is the fragment size of ice cubes in the blender.

In another example, the cooking appliance may be a sous vide device (not shown), or an air convection oven (not shown), which include both the heating element 102 and the motor 104.

The cooking appliance 100 further includes a sensor 106 to measure the physical quantity relevant to the processing performed by the cooking appliance 100. In the case of the toaster 20 this may be one of a photochromatic sensor, a temperature sensor, an infrared sensor. In the case of the blender 30, this may be a current sensor to determine a powerdraw of the motor, an accelerometer to measure vibrations, a camera to obtain visual indications of ice chunk size.

The cooking appliance 100 includes a microcontroller 110 configured to control the heating element 102 and/or the motor 104 at one or more set points. For example, the heating element 102 of the toaster 10 may typically be operated at two set points: “on” and “off”. Some toasters 10 may include the ability to operate the heating element 102 at set points between “on” and “off” to provide lower heat output of the heating element 102. The blender 20 may be operated at a multitude of set points between “off” and “full speed”.

The cooking appliance 100 further includes a memory 120 connected to the microcontroller 110 for storing information, the memory storing a loss function and a sensor function. The loss function defines the desirability of operating the heating element 102 and/or the motor 104 for each possible state of the food item. In the example of a basic toaster 20, when the bread is untoasted the value of the loss function for the set point “off” may be very high, while the value of the loss function for the set point “on” may be very low. The sensor function relates the output of the sensor 106 to a first probability. The first probability is a data set including probabilities for each possible state of the food item. In the example of the toaster 20, when the sensor 106 is a temperature sensor that outputs room temperature, the first probability value for the “untoasted” state may be very high, while the first probability value for the “shade-2” state may be very low.

The microcontroller 110 is configured to receive sensor information from the sensor 106 related to the physical quantity.

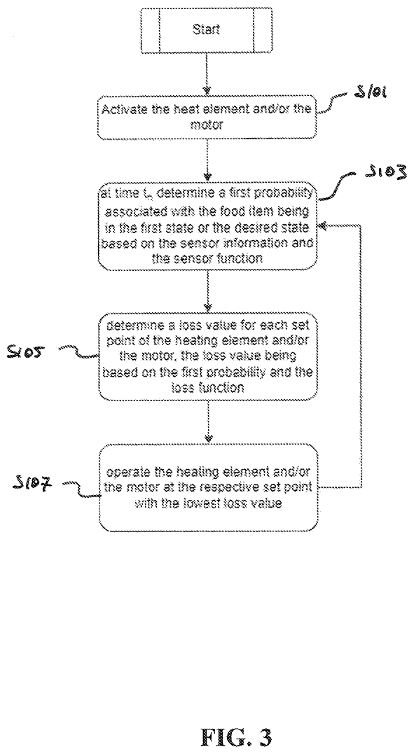

As shown in FIG. 3, in a typical basic operation, the microcontroller 110 is configured to start a processing operation by, at step S101, activating the heat element 102 and/or the motor 104. After step S101, or in some instance before or at the same time as step S101, the controller 110, at step S103 and time tₙ, determines the first probability associated with the food item being in the first state or the desired state, based on the sensor information and the sensor function. The controller 110 then, at step S105, determines a loss value for each set point of the heating element 102 and/or the motor 104, the loss value being based on the first probability and the loss function. Finally, at step S107, the controller 110 operates the heating element 102 and/or the motor 104 at the respective set point with the lowest loss value.

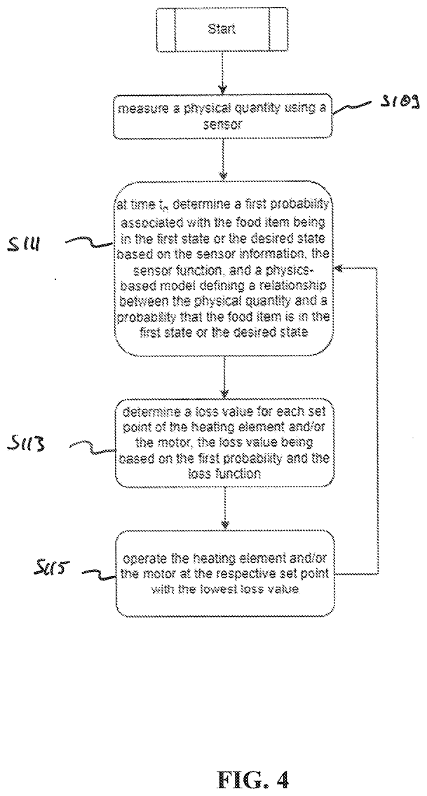

Moving to FIG. 4, this operation may be improved by the inclusion of a physics-based model that defines a relationship between the physical quantity measured by the sensor 106 and the first probability that the food item is in the first state or the desired state. At step S109, the physical quantity is measured using the sensor 106. At step S111 and time tₙ, determines the first probability associated with the food item being in the first state or the desired state, based on the sensor information and the physics-based model. The controller 110 then, at step S113, determines a loss value for each set point of the heating element 102 and/or the motor 104, the loss value being based on the first probability and the loss function. Finally, at step S115, the controller 110 operates the heating element 102 and/or the motor 104 at the respective set point with the lowest loss value.

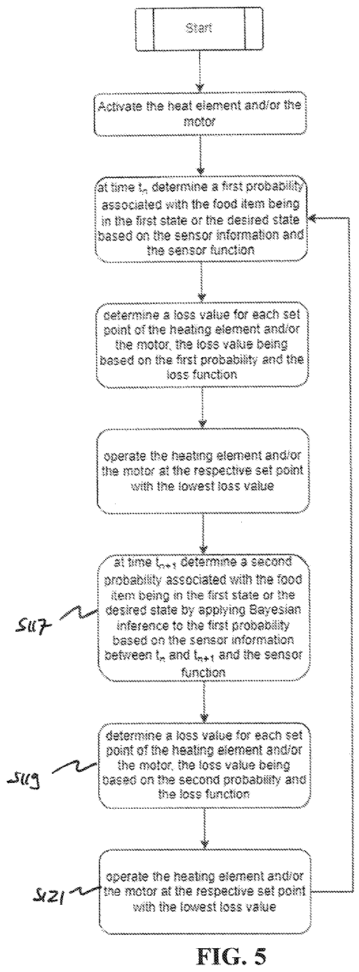

As the food item is being processed, the sensor information collected by the sensor 106 may change in accordance with the processing operation progressing. For example, a photochromatic sensor may show browning. Otherwise, natural divergences of sensor information will cause different readings of the sensor 106 over time. In order to integrate this new information, the method according to FIG. 5 proposes to, at step S117 and and time tₙ₊₁, determine a second probability associated with the food item being in the first state or the desired state, by applying Bayesian inference to the first probability based on the sensor information between tₙ and tₙ₊₁, and the sensor function. The controller 110 then, at step S119, determines a loss value for each set point of the heating element 102 and/or the motor 104, the loss value being based on the second probability and the loss function, and operate the heating element 102 and/or the motor 104 at step S121 at the respective set point with the lowest loss value. For continuously distributed variables, a Kalman filter, as shown in step S135 of FIG. 8 may be used.

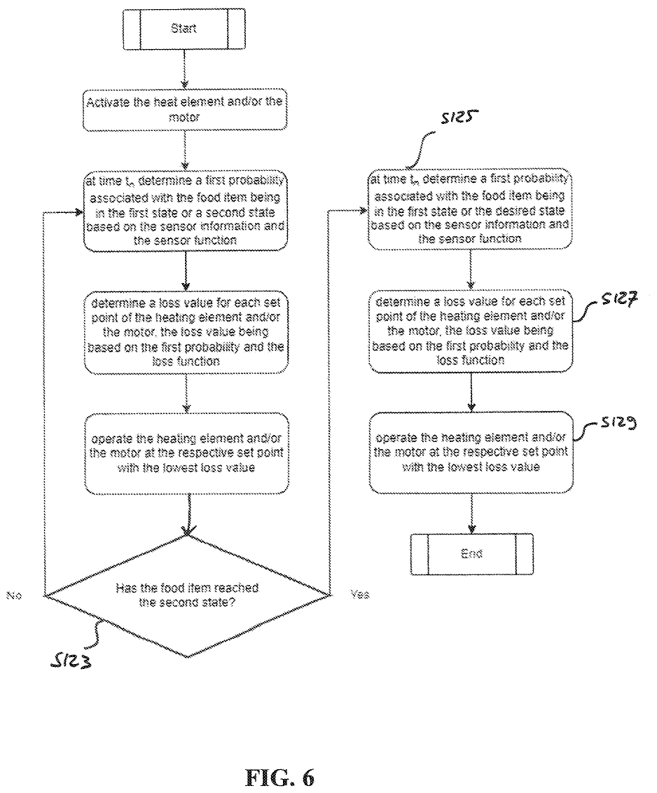

In some instances, it may be desirable to process the food item from the first state to a second state, before then processing the food item from the second state to the desired state. This allows the loss and/or sensor functions to be defined such that the most optimal path to the second state is indicated by the loss values at first, and then the most optimal path the desired state. For example, an oven roast might first require a searing step, where the set point for the heating element 102 should be quite high to achieve the quick sear desired, to be then followed by a longer roast, with a lower set point for the heating element 102 to achieve the desired core temperature of the food item, without burning the perimeter. To provide this functionality, in the method of FIG. 6 the controller 110, at step S103 determines the first probability also in relation to the second state. Further, at step S123, the controller 110 determines whether the food item has reached the second state. If the second state has not been reached, the controller 110 returns to step S103. If the food item has reached the second state, the controller 110 at step S125 and time tₙ, determines the first probability associated with the food item being in the first state or the desired state, based on the sensor information and the sensor function. The controller 110 then, at step S127, determines a loss value for each set point of the heating element 102 and/or the motor 104, the loss value being based on the first probability and the loss function. Finally, at step S129, the controller 110 operates the heating element 102 and/or the motor 104 at the respective set point with the lowest loss value.

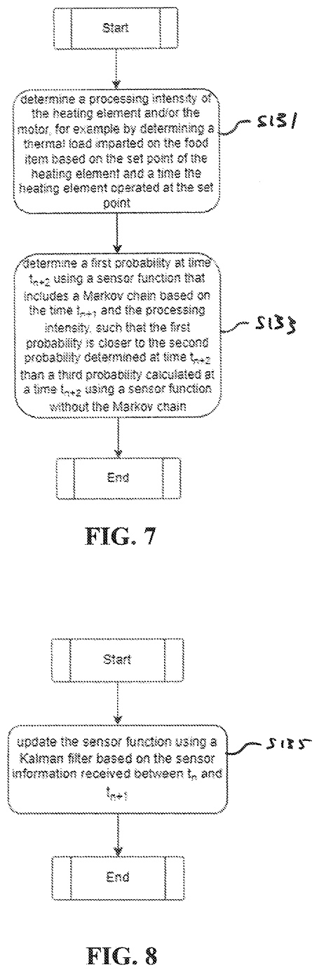

The method shown in FIG. 5 is necessarily a reactive control model, that allows the controller 110 to select the set point of the heating element 102 and/or motor 104 with the least damaging effect to the desired state of the food item. With an understanding of the physical processes involved in the processing of the food item, however, it is possible to predict the likely first probability at a future time tₙ₊₂, and adapted the loss and/or sensor function accordingly so that over or under shooting of the control model is less likely. For example, at FIG. 7, at step S131 the controller 110 determines a processing intensity of the heating element 102 and/or the motor 104. In one example, this may be by determining a thermal load (amount of power delivered over time) imparted on the food item based on the set point of the heating element 102 and a time the heating element 102 operated at the set point. The adjusted first probability at time tₙ₊₁ is determined by the controller 110 at step S133 using a sensor function that includes a Markov chain based on the first probability at the current time tₙ₊₁ and the processing intensity. Once the controller 110 has determined the loss values using this adjusted first probability and operated the heating element 102 and/or motor 104 using the corresponding set points, the second probability determined at time tₙ₊₂ will be closer to the first probability at time tₙ₊₂, compared to a third probability determined at time tₙ₊₂ if the controller 110 had not used the adjusted first probability at time tₙ₊₁. Thus, as a result of integrating the thermal load into the first probability using the Markov chain at time tₙ₊₁, the correction required using Bayesian inference at time tₙ₊₂ is reduced.

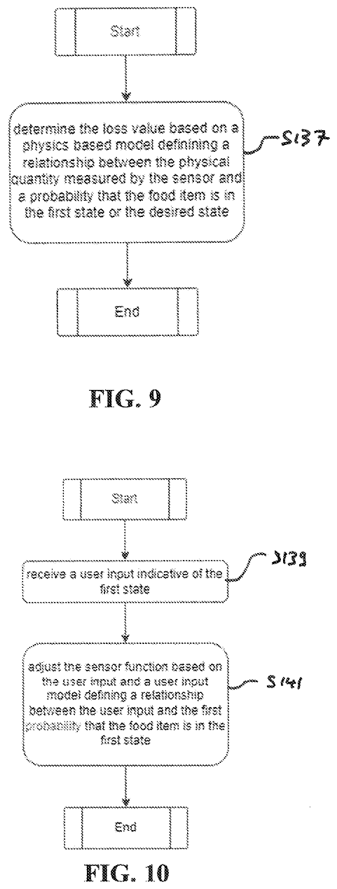

In some instances, it may be preferably for the physics-based model to be integrated into the loss function, rather than the sensor function as shown in FIG. 4. This is shown in step S137 of FIG. 9. Again, the physics-based model defines a relationship between the physical quantity measured by the sensor and a probability that the food item is in the first state or the desired state, but this information is applied by adjusting the loss values on the basis of the physics-based model, rather than adjusting the first probability.

Finally, as shown in FIG. 10, some information may be obtained by user input. Such as the “frozen”, “fruit bread”, or “crumpet” buttons found on some toasters. However, as user error can occur, user input should be moderated using a user input function that allows for the possibility that the bread type is not “fruit bread”, even though the “fruit bread” button has been selected at step S139. Thus, the user input is merely another function that acts on the first probability, rather than being determinative.

A basic concrete example of this operation may be explained using the toaster 10 of FIG. 1. The toaster 10 may have discrete shade settings that the user would operate to indicate the degree of shade desired on their toast, being the desired state of the food item. The shade s may be a whole number between 0 and S. It may be useful to assign shade s=−1 for frozen toast. In terms of other variables for the state of the food item, the bread being toasted may have different properties. For example, it may be a sour dough bread, brioche, a fruit bread, etc. It is known that these types of bread respond differently to heating. We can enumerate these using index values i from 0 to M.

Assuming that these properties of the food item are mutually exclusive and exhaustive, we can assume that:

$${\sum }_{i = 0 , 1 , … , M} {\sum }_{s = - 1 , 0 , 1 , … , S} p ( {θ}_{i}^{s} \vert I ) = 1 , where p ( {θ}_{i}^{s} \vert I )$$

is the first probability, being the current probability of the toast having a shade s and bread type i, given initial information I provided to the controller 110. One input of the initial information might be a user input, such as the “frozen”, “fruit bread”, or “crumpet” buttons found on some toasters. As discussed above, the user input may be factored into the first probability using the user input model. For example, if the user indicates that the bread is “crumpet”, there is a non-zero chance that the bread is not “crumpet”. The first probability is adjusted accordingly. There may be some basic assumptions that can also be made, for example based on market surveys it could be known that a third of bread starts frozen, almost two-thirds as untoasted, and a small proportion as already partly toasted.

The controller 110 will collected further data E as the food item is being processed. The data D may be acquired from sensors, such as a temperature sensor, photochromatic sensor, photosensor, pressure sensor, humidity sensor, oxygen or other gas sensor. The data E may be correlated to the state of the food item, being in this example the shade s and the bread type i.

In general, this Data is used according to the method of FIG. 5 to determine the second probability p(θ|DI). This can be obtained using Bayes theorem:

$$p ( θ \vert EI ) = p ( θ \vert I ) \frac{p ( E \vert θ I )}{p ( E \vert I )}$$

p(E|θ1), being the probability that the data E was collected given a particular state of bread and prior information can be estimated or determined using a stored model and forms the functional part of the sensor function. p(E|I) is not of particular importance, since it does not involve the active variable and is a normalizing term. p(0|I) is the first probability.

In accordance with the method, loss values are now determined by the controller 110 for each set point of the heating element 102. The toaster 10 may be assumed to have two set points: “on” (D₁) and “off” (D₀). The loss values may be expressed as:

$${〈 L 〉}_{1} = {\sum }_{j} p ( {θ}_{j} \vert EI ) L ( {D}_{1} , {θ}_{j} )$$

$${〈 L 〉}_{0} = {\sum }_{j} p ( {θ}_{j} \vert EI ) L ( {D}_{0} , {θ}_{j} ) .$$

Where L( ) is the loss function operated on the set of possible current states θⱼ assuming set point Dᵢ, given initial information I and further collected data E. One example of the loss function might be:

$$L ( {D}_{0} , {θ}_{j} ) = \{ \begin{matrix}{c}_{0} ( {θ}_{s} - 2 ) for 2 < {θ}_{s} \\ 0 for 2 \geq {θ}_{s}\end{matrix}$$

$$L ( {D}_{1} , {θ}_{j} ) = \{ \begin{matrix}0 for 2 < {θ}_{s} \\ {c}_{1} ( 2 - {θ}_{s} ) for 2 \geq {θ}_{s}\end{matrix}$$

Where θₛ is the shade of toast for the first probability for which the loss value is being calculated. In this example, the target shade is 2, and the loss value for the decision to continue heating D₁ for states in which the shade θₛ exceeds 2 is high, while the loss value for the decision to stop heating for states in which the shade θₛ is below 2 is high. Thus, the controller 110 will continue heating while the first probability indicates that the bread is likely below shade 2. The shape of the loss function, linear in the case above, may be adjusted to cause a quicker or slower decision to stop operating the heating element 102.

In a different example, the variables defining the state of the food item may be continuous. For example, when roasting a piece of meat in an oven, the core temperature, surface temperature, or other characteristics of the food item, are continuous. In these cases, the loss values may be obtained by:

$${〈 L 〉}_{j} = \int p ( θ ) L ( {D}_{j} , θ ; α ) d θ$$

Where p(θ) is the first probability, though the second probability p(θ|EI) may naturally also be used, determined using a Kalman filter, a is one of the characteristics of the food item. If more than one characteristic is being monitored, each is integrated separately to obtain the expected loss value. The loss function relating the characteristic a to the desired food state may be defined similarly to the discrete example provided above.

Performing these types of operation on a microprocessor that is typically used as the controller 110 in a benchtop device can be difficult, due to the limitations of the memory 120. Values are can be efficiently stored in microprocessors using floating point variables. To assist storing the probabilities and values involved in these calculations, which can often be very small or very large, the information can be stored as evidence, using the below translation tool:

$$e ( A \vert I ) = 10 {log}_{10} ( \frac{p ( A \vert I )}{p ( \overline{A} \vert I )} ) = 10 {log}_{10} O ( A \vert I )$$

This translates a probability expressed in the space 0 to 1 to an odds format. For example 10:1 odds would be probability 0.09090909 . . . , and can be expressed as evidence 10. Thus, evidence can use the entire addressable space for a signed floating point number, instead of just the space between 0 and 1, improving the efficiency and precision of calculations. Many operations required in this control algorithm can be performed directly using evidence. For example, the Bayesian evidence update may take the form of:

$$e ( A \vert EI ) = e ( A \vert I ) + 10 {log}_{10} ( \frac{p ( E \vert AI )}{p ( E \vert \overline{A} I )} )$$

If required, the probability can be recovered from the evidence using:

$$p ( A \vert I ) = {( 1 + 1 {0}^{- e ( A \vert I ) / 10} )}^{- 1}$$

In some instances, it may be preferable to divide the sensor function into a variable function that defines a relationship between the physical quantity and a probability that the food item is in the first state or the desired state, and a constant function that relates to physical quantities, or portions of measurement signals derived from physical quantities, that do not change value between the first state and the second state.

In order to improve computation times, the controller may be configured to only determine the loss value for a first state, second state, or desired state, where the second probability for that state exceeds a performance threshold. For states with extremely low probabilities, it is unlikely that the value of the loss function will elevate the probability above the probabilities of other states.

Advantages of the disclosed method will now be discussed.

Because the heating element 102 and/or the motor 104 are operated on the basis of a probabilistic heating algorithm, the control algorithm is able to better absorb differences in environmental factors, differing initial conditions before the processing operation, and operational differences between devices. The incorporation of a physics-based model allows the meaningful incorporation of data from the sensor 106 to assist in the determination of the first probability and/or the loss value, on which the controller 110 makes the decision between the set points. As a result, calibration curves, models, and/or regressions can be used to assist the feeding of sensor information into the probabilistic food processing control model.

Splitting the sensor function into a variable function and a constant function decreases the computational load on the likely restricted controller 110, that will usually be embodied as a limited-capability embedded processing device.

The use of Bayesian inference and/or a Kalman filter to update the probabilistic control model on the basis of new evidence allows continuous updates of the probability distribution underlying the control model. Progressing that model on the basis of a processing intensity, such as a thermal load, by including a Markov chain in the sensor function, allows the controller 110 to more rapidly progress the food item to the desired state, reducing under and over shooting by decreasing the difference between the probability update in each Bayesian inference or Kalman filter update.

1. A cooking appliance including:
a heating element and/or a motor for processing a food item from a first state to a desired state, each state being associated with a physical quantity;
a sensor to measure the physical quantity;
a microcontroller configured to control the heating element and/or the motor at one or more set points; and
a memory connected to the microcontroller for storing information, the memory storing a loss function and a sensor function;
wherein the microcontroller receives sensor information from the sensor related to the physical quantity and is configured to:
commence processing of the food item by activating the heating element and/or the motor;
at time tₙ, determine a first probability associated with the food item being in the first state or the desired state based on the sensor information and the sensor function;
determine a loss value for each set point of the heating element and/or the motor, the loss value being based on the first probability and the loss function; and
operate the heating element and/or the motor at the respective set point with the lowest loss value.

2. The cooking appliance of claim 1 wherein the sensor function includes a physics-based model defining a relationship between the physical quantity measured by the sensor and a probability that the food item is in the first state or the desired state, and the microcontroller is configured to determine the first probability also based on the physics-based model.

3. The cooking appliance of claim 1, wherein the physical quantity changes value between the first state and the desired state, and the sensor function includes:
a variable function that defines a relationship between the physical quantity and a probability that the food item is in the first state or the desired state; and
a constant function that defines a relationship between a physical constant and a probability that the food item is in the first state or the desired state, wherein the physical constant does not change value between the first state and the desired state.

4. The cooking appliance of claim 1, wherein the microcontroller is configured to:
at time tₙ₊₁, determine a second probability associated with the food item being in the first state or the desired state by applying Bayesian inference to the first probability, based on the sensor information received by the microcontroller between tₙ and tₙ₊₁ and the sensor function; and
determine the loss value for each set point of the heating element and/or the motor based on the second probability and the loss function.

5. The cooking appliance of claim 4, wherein the microcontroller is configured to update the sensor function using a Kalman filter based on the sensor information received by the microcontroller between tₙ and tₙ₊₁, and

6. The cooking appliance of claim 4, wherein the memory stores a physics-based model defining a relationship between the physical quantity measured by the sensor, the time tₙ₊₁, and a probability that the food item is in the first state or the desired state, and the microcontroller is configured to determine the loss value also based on the physics-based model.

7. The cooking appliance of claim 4, wherein the microcontroller is configured to determine a processing intensity of the heating element and/or the motor; and
wherein the sensor function includes a Markov chain based on the time tₙ₊₁ and the processing intensity such that the first probability calculated at a time tₙ₊₂ using the sensor function including the Markov chain is closer to the second probability calculated at the time tₙ₊₂ than a third probability calculated at a time tₙ₊₂ using the sensor function without the Markov chain.

8. The cooking appliance of claim 7, wherein the processing intensity is determined by the microcontroller by determining a thermal load imparted on the food item based on the set point of the heating element and a time the heating element operated at the set point.

9. The cooking appliance of claim 1, wherein the food item is processed from the first state to one or more second states and subsequently to the desired state, the microcontroller also being configured to determine the first probability for each second state.

10. The cooking appliance of claim 9, when dependent from claim 4, wherein the microcontroller is also configured to determine the second probability for each second state.

11. The cooking appliance of claim 10, wherein the microcontroller is configured to only determine the loss value for second states where the second probability exceeds a performance threshold.

12. The cooking appliance of claim 10, wherein the microcontroller is configured to only determine the loss value for second states where the loss function exceeds the performance threshold.

13. The cooking appliance of claim 1, wherein the microcontroller is configured to determine the loss function based on a user input of the desired state of the food item.

14. The cooking appliance of claim 13, wherein the heating element and/or the motor have a power-off set point, and the microcontroller is configured to determine the loss function such that the loss value of the power-off set point is lower than the loss value of other set points when the first probability of the food item being in the desired state has passed a finish threshold.

15. The cooking appliance of claim 1, wherein at time tₙ, the microcontroller is configured to adjust the sensor function based on a user input of the first state, and a user input model defining a relationship between the user input and a probability that the food item is in the first state or the desired state.

16. The cooking appliance of claim 15, wherein the physical quantity is continuous and there is a continuous distribution of states of the food item between the first state and the desired state, and
wherein the first probability is a continuous probability function from the first state to the desired state, and
wherein the user input model is a continuous probability function over the continuous distribution of states of the food item based on the user input.

17. The cooking appliance of claim 1, wherein the first probability is stored by the memory as a first evidence, the first evidence being defined as the logarithmic ratio of the first probability of the food item being in the relevant state and the first probability of the food item being in any state but the relevant state, such that the first probability is storable as a signed float.

18. A computer-readable memory containing executable instructions for the cooking appliance of claim 1, the executable instructions being adapted to configure the microcontroller as claimed in claim 1.

19. A method for controlling a cooking appliance, the cooking appliance including:
a heating element and/or a motor for processing a food item from a first state to a desired state, each state being associated with a physical quantity;
a sensor to measure the physical quantity;
a microcontroller configured to control the heating element and/or the motor at one or more set points; and
a memory connected to the microcontroller for storing information, the memory storing a loss function and a sensor function,
the method including the steps of:
commencing processing of the food item by activating the heating element and/or the motor;
at time tₙ, determining a first probability associated with the food item being in the first state or the desired state based on the sensor information and the sensor function;
determining a loss value for each set point of the heating element and/or the motor, the loss value being based on the first probability and the loss function; and
operating the heating element and/or the motor at the respective set point with the lowest loss value.
